(19) United States
(12) Patent Application Publication
(10) Pub. No.: US 2026/0269713 A1
(43) Pub. Date: Sep. 10, 2026

(54) POWER SUPPLY DEVICE AND SOLID ELECTROLYTIC CAPACITOR

(71) Applicant: Panasonic Intellectual Property Management Co., Ltd., Osaka (JP)

(72) Inventors: KOJI TAKAHASHI, Kanagawa (JP); SYUSAKU KOIE, Shiga (JP); KENJI KURANUKI, Kyoto (JP); NOBORU NEGORO, Osaka (JP); HIROYUKI HANDA, Osaka (JP)

(21) Appl. No.: 19/160,851

(22) PCT Filed: Feb. 13, 2024
(86) PCT No.: PCT/JP2024/004840

§ 371 Date: Aug. 28, 2025

(30) Foreign Application Priority Data
Mar. 16, 2023 (JP) 2023-041925

(51) Int. Cl. H02M 1/14; H01G 9/012; H01G 9/15; H01G 9/26; H02M 3/155

(52) U.S. Cl. CPC H02M 1/143; H01G 9/012; H01G 9/15; H01G 9/26; H02M 3/155

(57) ABSTRACT

A power supply device includes a switching regulator and a solid electrolytic capacitor, and is configured to input a DC voltage to a load circuit. The solid electrolytic capacitor includes a plurality of capacitor elements, two anode terminals, and a cathode terminal. The capacitor element includes an anode body and a cathode part. The anode body includes two protrusions, each of the two protrusions protruding from a corresponding one of both ends of the cathode part. Each of the two anode terminals is electrically connected to a corresponding one of the two protrusions, and the cathode terminal is electrically connected to the cathode part. One of the two anode terminals is connected to an output terminal of the switching regulator in a direct current manner. The other of the two anode terminals is connected to an input terminal of the load circuit in a direct current manner.

### TECHNICAL FIELD

The present disclosure relates to a power supply device and a solid electrolytic capacitor.

### BACKGROUND

Power supply devices configured to output low-noise DC voltage have been conventionally known (e.g., PTL 1). PTL 1 shows a power supply device including a switching regulator that outputs DC voltage, and a linear regulator that removes a noise component from the DC voltage of the switching regulator.

### CITATION LIST

### Patent Literature

PTL 1: Unexamined Japanese Patent Publication No. 2008-253001

### SUMMARY

An aspect of the present disclosure relates to a power supply device. The power supply device includes a switching regulator outputting a DC voltage, and a solid electrolytic capacitor smoothing the DC voltage of the switching regulator, and is configured to input the DC voltage smoothed by the solid electrolytic capacitor to a load circuit. The solid electrolytic capacitor includes a plurality of capacitor elements stacked on each other, two anode terminals, a cathode terminal, and an outer packaging resin covering the plurality of capacitor elements, the two anode terminals, and the cathode terminal so that a part of each of the two anode terminals and a part of the cathode terminal are exposed from the outer packaging resin. Each of the plurality of capacitor elements includes an anode body and a cathode part disposed on a surface of the anode body with a dielectric layer disposed between the anode body and the cathode part. The anode body includes two protrusions protruding from both ends of the cathode part. Each of the two anode terminals is electrically connected to a corresponding one of the two protrusions of the anode body, and the cathode terminal is electrically connected to the cathode part. The two protrusions in each of the plurality of capacitor elements are electrically conducted to each other. One of the two anode terminals is connected to an output terminal of the switching regulator in a direct current manner, and the other of the two anode terminals is connected to an input terminal of the load circuit in a direct current manner.

Another aspect of the present disclosure relates to a solid electrolytic capacitor. The solid electrolytic capacitor smooths a DC voltage output from a switching regulator and inputs the DC voltage to a load circuit. The solid electrolytic capacitor includes a plurality of capacitor elements stacked on each other, two anode terminals, a cathode terminal, and an outer packaging resin covering the plurality of capacitor elements, the two anode terminals, and the cathode terminal so that a part of each of the two anode terminals and a part of the cathode terminal are exposed from the outer packaging resin. Each of the plurality of capacitor elements includes an anode body and a cathode part disposed on a surface of the anode body with a dielectric layer disposed between the anode body and the cathode part. The anode body includes two protrusions protruding from both ends of the cathode part. Each of the two anode terminals is electrically connected to a corresponding one of the two protrusions of the anode body, and the cathode terminal is electrically connected to the cathode part. The two protrusions in each of the plurality of capacitor elements are electrically conducted to each other. One of the two anode terminals is connected to an output terminal of the switching regulator in a direct current manner, and the other of the two anode terminals is connected to an input terminal of the load circuit in a direct current manner.

The present disclosure enables obtaining a power supply device with small size, high efficiency, and little noise.

### BRIEF DESCRIPTION OF THE DRAWINGS

FIG. 1 is a circuit block diagram illustrating an example of a power supply device according to the present disclosure.

FIG. 2 is a lateral perspective view schematically illustrating a solid electrolytic capacitor according to a first exemplary embodiment.

FIG. 3 is a lateral sectional view schematically illustrating a capacitor element.

FIG. 4 is a perspective view schematically illustrating a plurality of the capacitor elements and a cathode terminal.

FIG. 5 is an equivalent circuit diagram of a solid electrolytic capacitor.

FIG. 6 is a lateral perspective view schematically illustrating a solid electrolytic capacitor according to a second exemplary embodiment.

FIG. 7 is a perspective view schematically illustrating a capacitor element.

FIG. 8 is a sectional view schematically illustrating a solid electrolytic capacitor of a third exemplary embodiment.

FIG. 9 is a sectional view taken along line IX-IX of FIG. 8.

### DESCRIPTION OF EMBODIMENT

A linear regulator has an operation principle that causes a control element to generate heat loss. The linear regulator also needs to be provided at its preceding stage and subsequent stage with decoupling capacitors. Thus, the power supply device of PTL 1 has room for improvement in terms of efficiency and size. In such a situation, the present disclosure provides a power supply device with small size, high efficiency, and little noise.

Exemplary embodiments of a power supply device and a solid electrolytic capacitor according to the present disclosure will be described below with reference to examples. However, the present disclosure is not limited to the examples described below. Although specific numerical values and materials may be provided as examples in the description below, other numerical values and materials may be used as long as the effect of the present disclosure can be obtained.

The power supply device according to the present disclosure can be suitably used as a power supply device for various load circuits (e.g., an analog load circuit that handles analog signals) that have strict noise requirements. The power supply device according to the present disclosure can also be used as a power supply device for load circuits (e.g., a digital load circuit that handles digital signals) that have not-so-strict noise requirements. The power supply device according to the present disclosure includes a switching regulator and the solid electrolytic capacitor according to the present disclosure, and is configured to input smoothed DC voltage to a load circuit.

The switching regulator outputs DC voltage. The switching regulator may step down DC voltage received with a leg including a pair of switching elements and output the DC voltage stepped down. The switching elements provided in the leg may be each a MOSFET or a bipolar transistor. When each switching element is the MOSFET, the MOSFET constituting an upper arm may be an N-channel MOSFET or a P-channel MOSFET, and the MOSFET constituting a lower arm may be an N-channel MOSFET. When each switching element is the bipolar transistor, the bipolar transistor constituting the upper arm may be an NPN bipolar transistor or a PNP bipolar transistor, and the bipolar transistor constituting the lower arm may be an NPN bipolar transistor.

The switching regulator may include a choke coil that is connected at one terminal to a connection point between the pair of switching elements. The choke coil includes the other terminal that may constitute an output terminal of the switching regulator.

The switching regulator may include a controller that performs ON/OFF control of the pair of switching elements based on input voltage to the load circuit (or input voltage to the solid electrolytic capacitor). The controller may perform the ON/OFF control of the pair of switching elements based on a comparison result between the input voltage (or divided voltage of the input voltage) and a predetermined reference voltage. Voltage comparison is performed by a voltage comparator that may include an analog circuit or a digital circuit. Although the voltage comparator including the analog circuit requires a reference voltage circuit for outputting a reference voltage, the voltage comparator including the digital circuit does not require such a reference voltage circuit because the voltage comparison is performed by a digital arithmetic circuit. The controller may include a drive circuit for performing the ON/OFF control on each switching element. The switching regulator may include an input voltage detector for taking account of information on input voltage to the switching regulator in the voltage comparison.

The switching regulator generates spike voltage when the pair of switching elements is turned on and off, and the spike voltage is superimposed on DC voltage output from the switching regulator as a noise component. The switching regulator includes an output terminal (e.g., the other terminal of the choke coil) that is connected to one anode terminal (described later) of the solid electrolytic capacitor in a direct current manner. Thus, the DC voltage including the noise component output from the switching regulator is input to the one anode terminal of the solid electrolytic capacitor.

The expression herein, “connected in a direct current manner”, in which one terminal (e.g., one anode terminal of the solid electrolytic capacitor) and another terminal (e.g., the output terminal of the switching regulator) are connected, includes not only connection in which both the terminals are directly connected by wiring, but also connection in which a circuit element (e.g., an inductor) with small direct current resistance is inserted between both the terminals.

The solid electrolytic capacitor smooths the DC voltage of the switching regulator. The solid electrolytic capacitor may smooth the DC voltage while maintaining its average value. The solid electrolytic capacitor may be a solid electrolytic capacitor with three terminals or a solid electrolytic capacitor with four terminals. The solid electrolytic capacitor with three terminals may include two anode terminals and one cathode terminal, and the solid electrolytic capacitor with four terminals may include two anode terminals and two cathode terminals.

The solid electrolytic capacitor includes a plurality of capacitor elements, two anode terminals, a cathode terminal, and an outer packaging resin. The anode terminals may be two or more in number, and the cathode terminal may be one or more in number.

The plurality of capacitor elements each have an anode body and a cathode part formed on a surface of the anode body with a dielectric layer interposed therebetween. A part of the anode body protrudes from each of both ends opposite to each other of the cathode part. Hereinafter, the part of the anode body is also referred to as a protrusion, the part protruding from each of both ends of the cathode part. The plurality of capacitor elements is stacked on each other. Each capacitor element includes the anode body with the two protrusions that are electrically connected to each other. Each capacitor element further includes an insulator provided between the anode body and the cathode part to electrically insulate the anode body and the cathode part from each other. The insulator may be composed of an insulating tape or an insulating resin, for example.

Each anode body may be made of a valve metal. Examples of the valve metal constituting the anode body include aluminum, tantalum, niobium, and titanium. The anode body may be foil of a valve metal or a sintered body of valve metal particles. Anode bodies adjacent to each other in a stacking direction may be electrically connected to each other.

The dielectric layer may be formed covering at least a part of the surface of the anode body. The dielectric layer may be made of an oxide (e.g., aluminum oxide) formed on the surface of the anode body by a liquid phase method such as anodic oxidation or a gas phase method such as vapor deposition and atomic layer deposition. The dielectric layer is formed while being interposed at least between the anode body and the cathode part.

The cathode part may include a solid electrolyte layer covering at least a part of a surface of the dielectric layer, and a cathode layer covering at least a part of a surface of the solid electrolyte layer. Cathode parts adjacent to each other in the stacking direction may be electrically connected to each other. The solid electrolyte layer may contain a conductive polymer. The solid electrolyte layer may further contain a dopant as necessary.

As the conductive polymer, a known polymer used for a solid electrolytic capacitor, such as a z-conjugated conductive polymer, can be used. Examples of the conductive polymer include polymers with respective basic skeletons of polypyrrole, polythiophene, polyaniline, polyfuran, polyacetylene, polyphenylene, polyphenylene vinylene, polyacene, and polythiophene vinylene. Among them, polymers with respective basic skeletons of polypyrrole, polythiophene, and polyaniline are preferable. The polymers described above also include a homopolymer, a copolymer of two or more kinds of monomers, and a derivative thereof (such as a substituent product with a substituent). Examples of the polythiophene include poly(3,4-ethylenedioxythiophene). One type of the conductive polymer may be used alone, or two or more types of the conductive polymer may be used in combination.

Available examples of the dopant include at least one type selected from the group consisting of a low molecular anion and a polyanion. Although examples of the low molecular anion include a sulfate ion, a nitrate ion, a phosphate ion, a borate ion, an organic sulfonate ion, and a carboxylate ion, the low molecular anion is not particularly limited. Examples of the dopant that generates the organic sulfonate ion include benzenesulfonic acid, p-toluenesulfonic acid, and naphthalenesulfonic acid. Examples of the polyanion include a polymer-type polysulfonic acid, and a polymer-type polycarboxylic acid. Examples of the polymer-type polysulfonic acid include a polyvinylsulfonic acid, a polystyrenesulfonic acid, a polyallylsulfonic acid, a polyacrylsulfonic acid, and a polymethacrylsulfonic acid. Examples of the polymer-type polycarboxylic acid include a polyacrylic acid and a polymethacrylic acid. The examples of the polyanion also include a polyester sulfonic acid and a phenolsulfonic acid novolak resin. However, the polyanion is not limited to those listed above.

The solid electrolyte layer may further contain a known additive agent and a known conductive material other than the conductive polymer as necessary. Examples of such a conductive material include conductive inorganic materials such as manganese dioxide and at least one selected from the group consisting of and TCNQ complex salts.

The cathode layer may include a carbon layer formed on the surface of the solid electrolyte layer and a conductor layer formed on a surface of the carbon layer. The conductor layer may be made of silver paste. Available examples of the silver paste include a composition containing silver particles and a resin component (binder resin). Although a thermoplastic resin may be used for the resin component, use of a thermosetting resin such as an imide resin or an epoxy resin is preferable.

The two anode terminals are electrically connected to the two respective protrusions of the anode body. In other words, one of the anode terminals (first anode terminal) is electrically connected to the protrusion protruding from one end of the cathode part, and the other of the anode terminals (second anode terminal) is electrically connected to the protrusion protruding from the other end of the cathode part. Each of the first anode terminal and the second anode terminal may be divided into two or more parts. The anode terminal may be made of copper, a copper alloy, aluminum, or an aluminum alloy, or may be plated. Each of the first anode terminal and the second anode terminal may be electrically connected to a corresponding one of the two protrusions of each of the anode bodies of the plurality of capacitor elements. The anode terminal may be electrically connected to the protrusion while being fixed by caulking, or may be electrically connected to the protrusion by welding (e.g., laser welding or resistance welding).

The cathode terminal is electrically connected to the cathode part. The cathode terminal may be electrically connected to each of cathode parts of the plurality of capacitor elements. The cathode terminal may be electrically connected to the cathode part with a conductive adhesive interposed therebetween. The cathode terminal may be made of copper, a copper alloy, aluminum, or an aluminum alloy, or may be plated. The cathode terminal may be identical in a constituent material to or different in the constituent material from the anode terminal. The cathode terminal may be divided into two or more parts.

The outer packaging resin is formed covering the plurality of capacitor elements, the anode terminals, and the cathode terminal such that a part of each of the anode terminals and a part of the cathode terminal are exposed from the outer packaging resin. The anode terminals and the cathode terminal each include the part exposed that functions as an external terminal of the solid electrolytic capacitor. The outer packaging resin may be made of an insulating resin material. The outer packaging resin may be a cured product of a thermosetting resin containing an epoxy resin, and may contain a filler as necessary, for example.

The solid electrolytic capacitor configured as described above causes the DC voltage including the noise component input to one of the anode terminals to pass through the plurality of capacitor elements stacked, thereby sufficiently removing the noise component. The solid electrolytic capacitor includes the other of the anode terminals that is connected to an input terminal of the load circuit in a direct current manner. Thus, the DC voltage output from the other of the anode terminals of the solid electrolytic capacitor, from which the noise component is removed (or the DC voltage smoothed by the solid electrolytic capacitor), is input to the load circuit and used as driving power thereof. As described above, the solid electrolytic capacitor according to the present disclosure smooths the DC voltage output from the switching regulator and inputs the DC voltage to the load circuit.

The load circuit may be a low noise amplifier or an A/D converter, for example. The load circuit may be also a load circuit that operates at a frequency in a GHz band (e.g., a frequency of 1 GHz or more, or 20 GHz or more). The load circuit may be also a low noise amplifier that treats a signal having a voltage level on the order of several tens of μV as an input signal.

Here, a power supply circuit according to the present disclosure includes a solid electrolytic capacitor that has an internal structure corresponding to decoupling capacitors on a preceding stage side and a subsequent stage side required by a conventional linear regulator. Specifically, the solid electrolytic capacitor has the internal structure in which an infinite number of LC low-pass filters are equivalently formed in a transmission line from one of anode terminals to the other of the anode terminals. In view of the one of the anode terminals, the solid electrolytic capacitor can be regarded as an element that exhibits a noise reduction function similar to that of the conventional decoupling capacitor on the preceding stage side. In view of the other of the anode terminals, the solid electrolytic capacitor can be regarded as an element that exhibits a noise reduction function similar to that of the conventional decoupling capacitor on the subsequent stage side. Thus, when the solid electrolytic capacitor is provided between the switching regulator and the load circuit, the conventional circuit configuration in which the decoupling capacitors on the preceding stage side and the subsequent stage side are added to the linear regulator can be replaced with one solid electrolytic capacitor, and thus the power supply circuit can be downsized.

The solid electrolytic capacitor provided in the power supply circuit according to the present disclosure does not generate a potential difference between input voltage and output voltage due to an internal structure in which the infinite number of the LC low-pass filters described above are equivalently formed. For this reason, heat loss due to a voltage drop does not substantially occur, and highly efficient operation can be performed as compared with the conventional linear regulator, thus improving efficiency of the power supply circuit.

The solid electrolytic capacitor provided in the power supply circuit according to the present disclosure further has an advantage of frequency characteristics excellent in a high frequency range. Specifically, characteristic evaluation of the solid electrolytic capacitor reveals that noise removal performance has been improved with an increase in frequency from a low frequency range to a high frequency range of about 100 MHz. In contrast, the conventional linear regulator is remarkably deteriorated in noise removal performance at a frequency exceeding about 1 MHz. In recent years, a switching regulator has tended to have a switching frequency exceeding about 1 MHz, so that the conventional linear regulator is less likely to remove a noise component generated by the switching regulator. On this point, the solid electrolytic capacitor of the present disclosure is excellent in frequency characteristics in a high frequency range as described above, so that a noise component generated by the switching regulator having a high switching frequency can be sufficiently removed.

The solid electrolytic capacitor also can be used by replacing one of the anode terminals with the other of the anode terminals. Based on the premise of the configuration of the power supply device according to the present disclosure, the output terminal of the switching regulator can be connected to the other of the anode terminals of the solid electrolytic capacitor in a direct current manner, and the input terminal of the load circuit can be connected to the one of the anode terminals of the solid electrolytic capacitor in a direct current manner, for example. Even this connection enables the solid electrolytic capacitor to exhibit functions similar to those described above.

The load circuit may be an analog load circuit. The analog load circuit has a severe noise requirement to handle an analog signal. The power supply device according to the present disclosure including the solid electrolytic capacitor described above can operate even the analog load circuit described above stably. The load circuit may be a digital load circuit.

The cathode terminal may include a mounting surface part exposed from the outer packaging resin, and a side wall part rising continuously from the mounting surface part and electrically connected to a side surface of each cathode part. This configuration allows the mounting surface part and the side wall part to be integrally formed with each other. The mounting surface part may be electrically connected to the cathode part of the capacitor element closest to the mounting surface part. The side wall part may be electrically connected to the side surface of each cathode part with a conductive adhesive interposed therebetween. The presence of the side wall part described above reduces impedance derived from a resistance component and an inductance component of the cathode terminal, so that the solid electrolytic capacitor can be improved in noise filter characteristics. The side wall part is formed integrally with the mounting surface part, so that the cathode terminal including the mounting surface part and the side wall part can be easily produced by bending a predetermined frame raw material, for example. Thus, the solid electrolytic capacitor can achieve both good noise filter characteristics and ease of manufacturing.

Each cathode part may include a first part with a first width and a second part with a second width smaller than the first width. The cathode terminal may include a side wall part electrically connected to a side surface of the second part of the cathode part. The side wall part may be electrically connected to the side surface of the second part of each cathode part. The side wall part may be electrically connected to the side surface of the second part of the cathode part with a conductive adhesive interposed therebetween. The presence of the side wall part described above reduces impedance derived from a resistance component and an inductance component of the cathode terminal, so that the solid electrolytic capacitor can be improved in noise filter characteristics. Thus, the solid electrolytic capacitor can be improved in the noise filter characteristics by the second part constituting a narrow part and the side wall part electrically connected to the side surface of the second part.

The solid electrolytic capacitor may further include a cathode foil electrically connected to the cathode part. An end surface of the protrusion of the anode body may be electrically connected to the anode terminal. An end surface of the cathode foil may be electrically connected to the cathode terminal. Between the end surface of the protrusion and the anode terminal, a plating layer may or may not be interposed. Between the end surface of the cathode foil and the cathode terminal, a plating layer may or may not be interposed. This configuration reduces impedance derived from an inductance component between the anode terminal and the anode body and an inductance component between the cathode terminal and the cathode foil, so that the solid electrolytic capacitor can be improved in the noise filter characteristics.

The power supply device may further include a decoupling capacitor that smooths DC voltage of the switching regulator. The power supply device may be configured to input the DC voltage smoothed by the decoupling capacitor to the digital load circuit. The decoupling capacitor may be connected to the output terminal of the switching regulator in parallel with the solid electrolytic capacitor. This configuration enables one switching regulator to operate both the load circuit and the digital load circuit stably. Between the switching regulator and the digital load circuit, a solid electrolytic capacitor of the type described above may not be provided. The digital load circuit may be a circuit in which a larger current flows than in the load circuit. The digital load circuit may be an arithmetic circuit such as a CPU or a GPU, for example. One or more decoupling capacitors may be provided, and the number of the decoupling capacitors is not particularly limited. When a plurality of decoupling capacitors are provided, the decoupling capacitors may have capacitance values that are identical to or different from each other. Although the digital load circuit may itself be a noise source when handling relatively large currents, the solid electrolytic capacitor exists in a path from the digital load circuit to the load circuit. Thus, noise generated by the digital load circuit is attenuated by the solid electrolytic capacitor to be less likely to affect the load circuit.

The switching regulator outputs DC voltage that may be controlled based on a voltage value corresponding to the load circuit and a voltage value corresponding to the digital load circuit. The voltage value corresponding to the load circuit may be a voltage value at one of the anode terminals of the solid electrolytic capacitor corresponding to the load circuit, a voltage value at the other of the anode terminals of the solid electrolytic capacitor, or a voltage value at the input terminal of the load circuit. The voltage value corresponding to the digital load circuit may be a voltage value between the switching regulator and the decoupling capacitor, or may be a voltage value at an input terminal of the digital load circuit. The load circuit and the digital load circuit each have a voltage range defined for normal operation. Control in the present configuration may be performed to cause the DC voltage output by the switching regulator to fall within the voltage range described above in each circuit. This control enables one switching regulator to operate both the load circuit and the digital load circuit more stably.

The power supply circuit may further include a decoupling capacitor provided between the anode terminal of the solid electrolytic capacitor and the ground. This configuration enables noise components transmitted to the load circuit to be further reduced. The decoupling capacitor may have a larger or smaller capacitance value than the solid electrolytic capacitor. Here, when the solid electrolytic capacitor is viewed from the load circuit, the solid electrolytic capacitor acts like a general two-terminal capacitor, for fluctuation of the voltage value at the input terminal of the load circuit. That is, when a current flows into the load circuit, the fluctuation of the voltage value may not be suppressed only by the solid electrolytic capacitor. When the fluctuation of the voltage value is not suppressed, providing a decoupling capacitor (especially, a decoupling capacitor having a self-resonant frequency close to an operating frequency of the load circuit) having a capacitance different from that of the solid electrolytic capacitor enables suppressing the fluctuation of the voltage value. The decoupling capacitor includes one terminal that may be connected to the other of the anode terminals (or the input terminal of the load circuit) of the solid electrolytic capacitor in a direct current manner. The decoupling capacitor includes the other terminal that may be grounded. When the decoupling capacitor is provided between the ground and the anode terminal connected to the output terminal of the switching regulator in a direct current manner, the decoupling capacitor mainly has a function of removing noise from the switching regulator. In contrast, when the decoupling capacitor is provided between the anode terminal connected to the input terminal of the load circuit in a direct current manner and the ground, the decoupling capacitor has a function of suppressing fluctuation of a voltage value at the input terminal of the load circuit in addition to the function of removing noise.

A plurality of load circuits may be provided. At least one solid electrolytic capacitor may be provided for each load circuit. The load circuits may have frequencies identical to or different from each other. When the frequencies are different from each other, noise between the load circuits may be a problem. For the problem, at least one solid electrolytic capacitor is provided for each load circuit in this configuration. Thus, even when noise is generated by one load circuit, at least two solid electrolytic capacitors exist in a path through which the noise is transmitted to another load circuit. For this reason, noise can be prevented from being transmitted among the plurality of load circuits to achieve stable operation of each load circuit.

The switching regulator outputs DC voltage that may be controlled based on voltage values corresponding to respective load circuits. The voltage value corresponding to the load circuit may be a voltage value at one of the anode terminals of the solid electrolytic capacitor corresponding to the load circuit, a voltage value at the other of the anode terminals of the solid electrolytic capacitor, or a voltage value at the input terminal of the load circuit. Each load circuit has a voltage range defined for normal operation. Control in the present configuration may be performed to cause the DC voltage output by the switching regulator to fall within the voltage range described above in each load circuit. This control enables one switching regulator to operate the plurality of load circuits more stably.

The switching regulator outputs DC voltage that may be controlled based on a voltage value detected between the solid electrolytic capacitor and the load circuit. The voltage value (i.e., a voltage value detected at the subsequent stage of the solid electrolytic capacitor) includes fewer noise components than a voltage value detected at the preceding stage of the solid electrolytic capacitor. Thus, when the DC voltage of the switching regulator is controlled based on a voltage value with fewer noise components as described above, the control can be further stabilized. When the decoupling capacitor is provided between the solid electrolytic capacitor and the load circuit, the DC voltage output by the switching regulator is preferably controlled based on a voltage value detected between the decoupling capacitor and the load circuit (i.e., a subsequent stage of the decoupling capacitor).

The solid electrolytic capacitor may have a capacitance value of 80 μF or more. When the capacitance value is 80 μF or more, a sufficient noise reduction effect can be obtained. When the switching regulator has a switching frequency in the MHz band, the noise reduction effect tends to increase as the capacitance value of the solid electrolytic capacitor increases. Each of decoupling capacitors provided at the preceding stage and the subsequent stage of the conventional linear regulator has a capacitance value of about 20 μF in many cases, so that the solid electrolytic capacitor of the present configuration having a capacitance value of 80 μF or more enables the noise reduction effect to be greatly improved as compared with a conventional decoupling capacitor.

The power supply device may further include a decoupling capacitor that smooths DC voltage of the switching regulator, and a digital load circuit that receives the DC voltage smoothed by the decoupling capacitor. A plurality of load circuits may be provided. At least one solid electrolytic capacitor may be provided for each load circuit. The switching regulator outputs DC voltage that may be controlled based on voltage values corresponding to the respective load circuits and a voltage value corresponding to the digital load circuit. This configuration enables one switching regulator to operate both the plurality of load circuits and the digital load circuit more stably.

As described above, the present disclosure enables providing a power supply device with small size, high efficiency, and little noise by using a solid electrolytic capacitor having a predetermined structure. The present disclosure also enables providing a power supply device capable of sufficiently removing a noise component even when a switching frequency of a switching regulator increases.

Hereinafter, an example of each of the power supply device and the solid electrolytic capacitor according to the present disclosure will be specifically described with reference to the drawings. The components described above are applicable to components of the example described below of each of the power supply device and the solid electrolytic capacitor. The components of the example described below of each of the power supply device and the solid electrolytic capacitor can be changed based on the above description. Matters described below may be applied to the exemplary embodiment described above. The components of the example described below of each of the power supply device and the solid electrolytic capacitor include non-essential components to the solid electrolytic capacitor according to the present disclosure that may be eliminated. The drawings described below are schematic, and thus do not accurately reflect the shape and number of actual members.

### First Exemplary Embodiment

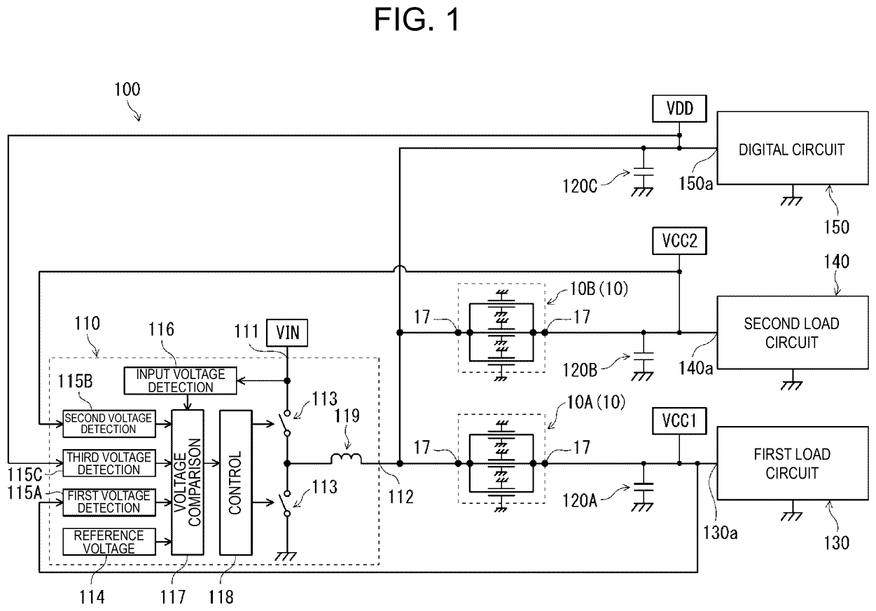

A first exemplary embodiment of the present disclosure will be described. As illustrated in FIG. 1, power supply device 100 according to the present exemplary embodiment includes switching regulator 110, first and second solid electrolytic capacitors 10A, 10B, and first to third decoupling capacitors 120A to 120C. Power supply device 100 is configured to input a direct current voltage (or DC power) to each of first and second load circuits 130,140 and digital load circuit 150. Each of first and second solid electrolytic capacitors 10A, 10B is an example of a solid electrolytic capacitor. Each of first and second load circuits 130, 140 is an example of a load circuit. Each drawing may denote first and second solid electrolytic capacitors 10A, 10B by reference mark 10.

Switching regulator 110 steps down DC voltage input to input terminal 111 and outputs the stepped-down DC voltage from output terminal 112. Switching regulator 110 includes a pair of switching elements 113, a reference voltage unit 114, first to third voltage detectors 115A to 115C, input voltage detector 116, voltage comparator 117, controller 118, and choke coil 119.

Each of the pair of switching elements 113 includes an N-channel MOSFET. Switching element 113 constituting the upper arm includes a drain that is electrically connected to input terminal 111 of switching regulator 110, and the MOSFET includes a source that is electrically connected to the drain of switching element 113 constituting the lower arm. Switching element 113 constituting the lower arm includes a source that is grounded.

Reference voltage unit 114 outputs a predetermined reference voltage. The output reference voltage is input to voltage comparator 117. Reference voltage unit 114 may be provided only when voltage comparator 117 includes an analog circuit, and is unnecessary when voltage comparator 117 includes a digital circuit.

First voltage detector 115A detects voltage VCC1 input to first load circuit 130. Voltage comparator 117 receives a signal of voltage VCC1 detected. Voltage VCC1 is an example of a voltage value corresponding to the load circuit.

Second voltage detector 115B detects voltage VCC2 input to second load circuit 140. Voltage comparator 117 receives a signal of voltage VCC2 detected. Voltage VCC2 is an example of a voltage value corresponding to the load circuit.

Third voltage detector 115C detects voltage VDD input to digital load circuit 150. Voltage comparator 117 receives a signal of voltage VDD detected. Voltage VDD is an example of a voltage value corresponding to the digital circuit.

Input voltage detector 116 detects voltage VIN input to switching regulator 110. Voltage comparator 117 receives a signal of voltage VIN detected.

Voltage comparator 117 compares the reference voltage received from reference voltage unit 114 with voltage VCC1, voltage VCC2, and voltage VDD, and transmits a signal of a result of the comparison to controller 118. Operation of voltage comparator 117 may be adjusted based on voltage VIN.

Controller 118 controls the pair of switching elements 113 so that they are alternately turned on and off. Based on the signal of the result of the comparison received from voltage comparator 117, controller 118 performs ON/OFF control on the pair of switching elements 113 to cause switching regulator 110 to output voltage at a desired level. Controller 118 may perform the ON/OFF control on each switching element 113 by raising and lowering a gate voltage of corresponding one of switching elements 113.

Choke coil 119 includes one terminal connected to a connection point between the pair of switching elements 113, and the other terminal constituting output terminal 112 of switching regulator 110. Choke coil 119 has a function of smoothing a rectangular wave voltage generated by the ON/OFF control of the pair of switching elements 113. The other terminal of choke coil 119 (output terminal 112 of switching regulator 110) is connected to one of anode terminals 17 of first solid electrolytic capacitor 10A, one of anode terminals 17 of second solid electrolytic capacitor 10B, and input terminal 150a of digital load circuit 150 in a direct current manner.

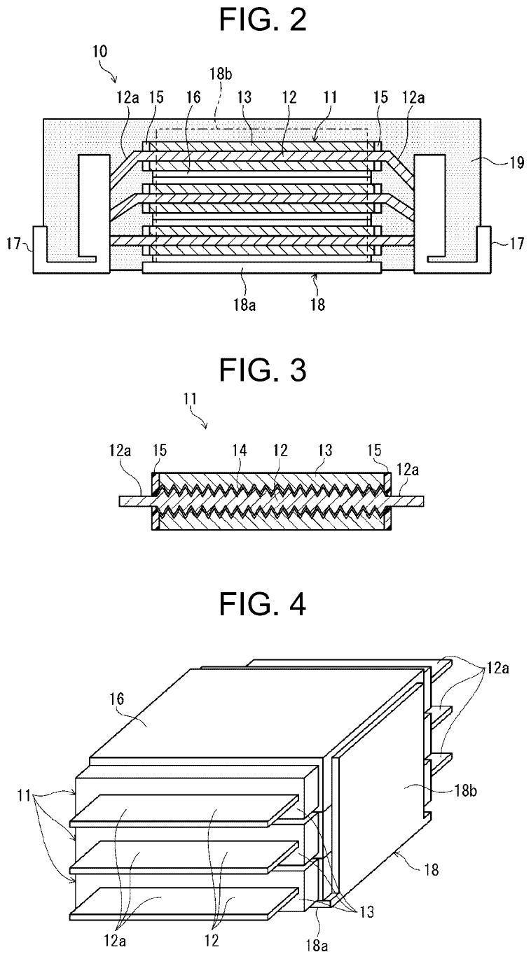

First solid electrolytic capacitor 10A smooths DC voltage of switching regulator 110. First solid electrolytic capacitor 10A preferably has a capacitance value of 80 μF or more. As illustrated in FIGS. 2 to 4, first solid electrolytic capacitor 10A includes a plurality of (three in this example) capacitor elements 11, two anode terminals 17, cathode terminal 18, and outer packaging resin 19. FIG. 2 illustrates side wall part 18b to be described later that is indicated by a two-dot chain line.

Each of the plurality of capacitor elements 11 includes anode body 12 and cathode part 13 formed on a surface of anode body 12 with dielectric layer 14 interposed therebetween, and cathode part 13 has both ends (left and right ends in FIG. 2) opposite to each other, from each of which a part of anode body 12 protrudes. Hereinafter, the part of anode body 12 protruding from a corresponding one of both the ends of cathode part 13 is also referred to as protrusion 12a. Capacitor elements 11 are stacked on each other. Each capacitor element 11 includes anode body 12 with two protrusions 12a that are electrically connected to each other. Each capacitor element 11 further includes insulator 15 provided between anode body 12 and cathode part 13 to electrically insulate anode body 12 and cathode part 13 from each other.

Anode body 12 is made of foil of a valve metal (aluminum in this example), but is not limited thereto. Anode bodies 12 adjacent to each other in the stacking direction are electrically connected to each other. Thus, all anode bodies 12 are electrically connected to each other.

Dielectric layer 14 is formed covering at least a part of the surface of anode body 12. Dielectric layer 14 is made of oxide (aluminum oxide in this example) formed on the surface of anode body 12 subjected to roughening treatment, but is not limited thereto.

Cathode part 13 includes a solid electrolyte layer covering at least a part of dielectric layer 14, and a cathode layer covering at least a part of the solid electrolyte layer. Cathode parts 13 adjacent to each other in the stacking direction are electrically connected to each other with conductive paste 16 interposed therebetween. Consequently, all cathode parts 13 are electrically connected to each other. The solid electrolyte layer contains a conductive polymer and a dopant.

The cathode layer includes a carbon layer formed on a surface of the solid electrolyte layer and a conductor layer formed on a surface of the carbon layer. The conductor layer may be made of silver paste.

Two anode terminals 17 are electrically connected to two respective protrusions 12a of anode body 12. Anode terminal 17 is made of a copper alloy, but is not limited thereto. Anode terminal 17 is electrically connected to protrusion 12a while being fixed by caulking. Instead of or in addition to being fixed by caulking, anode terminal 17 may be welded to protrusion 12a.

Cathode terminal 18 is electrically connected to cathode parts 13 with a conductive adhesive interposed therebetween, for example. Cathode terminal 18 is made of a copper alloy, but is not limited thereto. Cathode terminal 18 is identical in a constituent material to anode terminal 17.

Outer packaging resin 19 is formed covering the plurality of capacitor elements 11, anode terminals 17, and cathode terminal 18 while exposing a part of each of anode terminals 17 and a part of cathode terminal 18. Anode terminals 17 and cathode terminal 18 each include the part exposed that functions as an external terminal of first solid electrolytic capacitor 10A. Outer packaging resin 19 is made of an insulating resin material containing a filler.

Cathode terminal 18 includes mounting surface part 18a exposed from outer packaging resin 19, and side wall part 18b rising continuously from mounting surface part 18a and electrically connected to a side surface of each cathode part 13. Mounting surface part 18a is electrically connected to cathode part 13 of capacitor element 11 closest (lowermost in FIG. 2) to mounting surface part 18a. Side wall part 18b is electrically connected to the side surface of each cathode part 13 with a conductive adhesive (not illustrated) interposed therebetween.

Cathode terminal 18 preferably includes two or more side wall parts 18b that are electrically connected to corresponding side surfaces on both sides (side surfaces forward and backward on the paper in FIG. 2) of each cathode part 13.

First solid electrolytic capacitor 10A includes one anode terminal 17 that is connected to output terminal 112 of switching regulator 110 in a direct current manner First solid electrolytic capacitor 10A includes another anode terminal 17 that is connected to input terminal 130a of first load circuit 130 in a direct current manner. First solid electrolytic capacitor 10A includes a cathode terminal that is grounded.

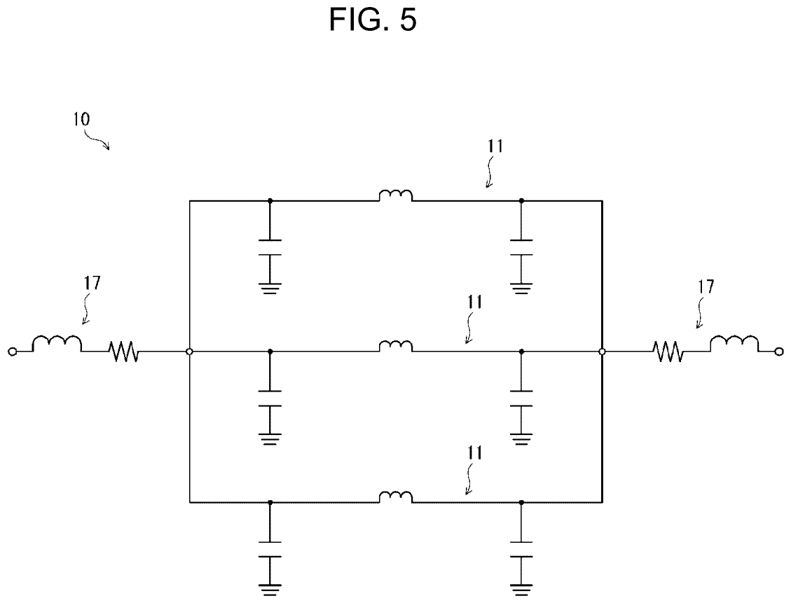

FIG. 5 illustrates an equivalent circuit of first solid electrolytic capacitor 10A. This equivalent circuit diagram does not indicate an element symbol corresponding to cathode terminal 18. As illustrated in FIG. 5, each anode terminal 17 includes an inductance component and a resistance component. Each capacitor element 11 includes an inductance component corresponding to anode body 12 and capacitance components located on both sides of the inductance component. As can be seen from the equivalent circuit diagram, first solid electrolytic capacitor 10A includes inductance components corresponding to the plurality of capacitor elements 11, the inductance components being coupled in parallel and forming combined inductance (i.e., equivalent series inductance of solid electrolytic capacitor 10A) that is small. First solid electrolytic capacitor 10A also includes capacitance components corresponding to the plurality of capacitor elements 11, the capacitance components being coupled in parallel and forming combined capacitance (i.e., a capacitance value of first solid electrolytic capacitor 10A) that is large.

Second solid electrolytic capacitor 10B has the same configuration and function as first solid electrolytic capacitor 10A, and thus the configuration and function will not be described. Second solid electrolytic capacitor 10B includes one anode terminal 17 that is connected to output terminal 112 of switching regulator 110 in a direct current manner. Second solid electrolytic capacitor 10B includes another anode terminal 17 that is connected to input terminal 140a of second load circuit 140 in a direct current manner. Second solid electrolytic capacitor 10B includes cathode terminal 18 that is grounded.

Returning to FIG. 1, first decoupling capacitor 120A is provided between first solid electrolytic capacitor 10A and first load circuit 130. First decoupling capacitor 120A includes a capacitor with two terminals including one terminal that is connected to the other of anode terminal 17 of first solid electrolytic capacitor 10A in a direct current manner, and the other terminal that is grounded. In other words, first decoupling capacitor 120A is provided between the other of anode terminals 17 of first solid electrolytic capacitor 10A and the ground. First decoupling capacitor 120A attenuates a noise component that cannot be removed by first solid electrolytic capacitor 10A.

Second decoupling capacitor 120B is provided between second solid electrolytic capacitor 10B and second load circuit 140. Second decoupling capacitor 120B includes a capacitor with two terminals including one terminal that is connected to the other of anode terminal 17 of second solid electrolytic capacitor 10B in a direct current manner, and the other terminal that is grounded. In other words, second decoupling capacitor 120B is provided between the other of anode terminals 17 of second solid electrolytic capacitor 10B and the ground. Second decoupling capacitor 120B attenuates a noise component that cannot be removed by second solid electrolytic capacitor 10B.

Here, instead of or in addition to first decoupling capacitor 120A, a fourth decoupling capacitor (not illustrated) for smoothing output voltage of switching regulator 110 may be provided between first solid electrolytic capacitor 10A and switching regulator 110. Instead of or in addition to second decoupling capacitor 120B, a fifth decoupling capacitor (not illustrated) for smoothing output voltage of switching regulator 110 may be provided between second solid electrolytic capacitor 10B and switching regulator 110.

Third decoupling capacitor 120C is provided between switching regulator 110 and digital load circuit 150. Third decoupling capacitor 120C includes a capacitor with two terminals including one terminal that is connected to output terminal 112 of switching regulator 110 in a direct current manner, and the other terminal that is grounded. In other words, third decoupling capacitor 120C is provided between output terminal 112 of switching regulator 110 and the ground. Third decoupling capacitor 120C smooths DC voltage of switching regulator 110.

First load circuit 130 receives DC voltage smoothed by first solid electrolytic capacitor 10A and first decoupling capacitor 120A, and performs a desired operation with the DC voltage. First load circuit 130 includes input terminal 130a that is connected to the other of anode terminals 17 of first solid electrolytic capacitor 10A in a direct current manner. First load circuit 130 of the present exemplary embodiment includes a low noise amplifier that is an example of an analog load circuit, but is not limited thereto.

Second load circuit 140 receives DC voltage smoothed by second solid electrolytic capacitor 10B and second decoupling capacitor 120B, and performs a desired operation with the DC voltage. Second load circuit 140 includes input terminal 140a that is connected to the other of anode terminals 17 of second solid electrolytic capacitor 10B in a direct current manner. Second load circuit 140 of the present exemplary embodiment includes an A/D converter that is an example of an analog load circuit, but is not limited thereto.

Digital load circuit 150 is subjected to DC voltage smoothed by third decoupling capacitor 120C, and performs a desired operation by the DC voltage. Digital load circuit 150 includes input terminal 150a that is connected to output terminal 112 of switching regulator 110 in a direct current manner. Digital load circuit 150 has a large S/N ratio to operate between a high potential and a low potential, and is less stringent in noise requirement than first and second load circuits 130, 140. For this reason, no circuit element corresponding to first and second solid electrolytic capacitors 10A, 10B needs to be provided between digital load circuit 150 and switching regulator 110. Digital load circuit 150 of the present exemplary embodiment includes an arithmetic circuit, but is not limited thereto.

### Second Exemplary Embodiment

A second exemplary embodiment of the present disclosure will be described. Power supply device 100 of the present exemplary embodiment is different in configuration of first and second solid electrolytic capacitors 10A, 10B from that of the first exemplary embodiment. Hereinafter, differences from the first exemplary embodiment will be mainly described.

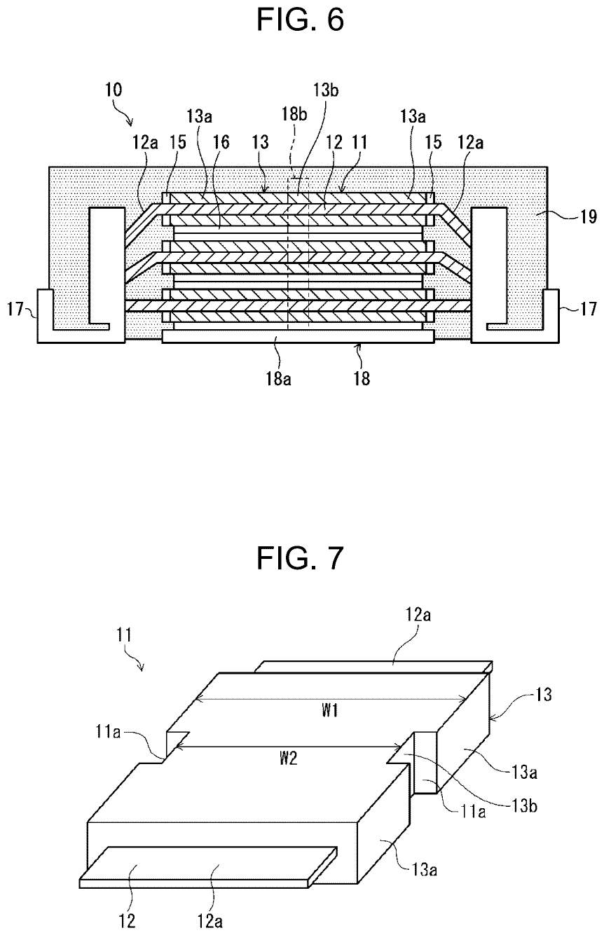

As illustrated in FIGS. 6 and 7, first and second solid electrolytic capacitors 10A, 10B of the present exemplary embodiment include cathode parts 13 that each include first part 13a with a first width and second part 13b with a second width smaller than the first width. Second part 13b is preferably disposed at a center of cathode part 13 in a longitudinal direction of cathode part 13 (a direction connecting two protrusions 12a). Two first parts 13a may be provided across second part 13b in the longitudinal direction of cathode part 13.

It is preferable to satisfy W2/W1≤0.95 where W1 is the first width and W2 is the second width, and is more preferable to satisfy 0.5≤W2/W1≤0.95.

Each capacitor element 11 preferably has opposite side surfaces each having recess 11a corresponding to second part 13b. Recess Ila preferably has a rectangular shape or a trapezoidal shape (especially, a trapezoidal shape that decreases in width toward the center in the width direction of capacitor element 11) as viewed in the stacking direction of the plurality of capacitor elements 11. Recess 11a may accommodate side wall part 18b. FIG. 7 illustrates capacitor element 11 provided with recess 11a in a rectangular shape.

Although not illustrated, cathode terminal 18 may further include an additional side wall part rising continuously from mounting surface part 18a and electrically connected to a side surface of first part 13a of each cathode part 13. The additional side wall part may have a smaller or larger width than the side wall part 18b, or may be equal in width to the side wall part 18b.

### Third Exemplary Embodiment

A third exemplary embodiment of the present disclosure will be described. Power supply device 100 of the present exemplary embodiment is different in configuration of first and second solid electrolytic capacitors 10A, 10B from that of the first exemplary embodiment. Hereinafter, differences from the first exemplary embodiment will be mainly described.

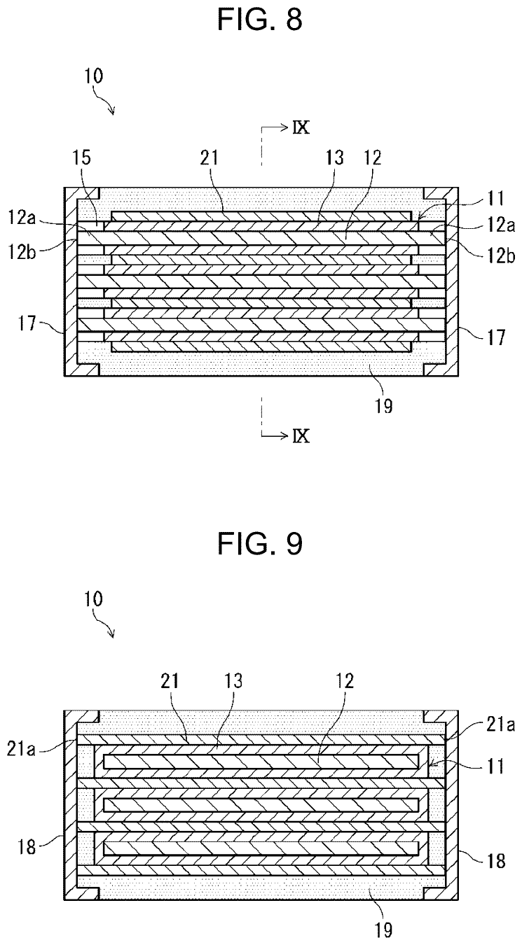

As illustrated in FIGS. 8 and 9, first and second solid electrolytic capacitors 10A, 10B of the present exemplary embodiment each include cathode foil 21 electrically connected to cathode part 13, two anode terminals 17, and two cathode terminals 18.

A plurality of (four in this example) pieces of cathode foil 21 is provided, and cathode foil 21 is interposed between capacitor elements 11 adjacent to each other in the stacking direction. Each cathode foil 21 extends in a direction orthogonal to a longitudinal direction of anode body 12 (a direction connecting two protrusions 12a). Cathode foil 21 may be composed of aluminum foil, copper foil, or metal foil made of a valve metal or an alloy including a valve metal, for example. As needed, a surface of cathode foil 21 may be roughened. Between cathode foil 21 and cathode part 13, an adhesive layer (not illustrated) having conductivity may be interposed. The adhesive layer is formed using a conductive adhesive, for example. The adhesive layer contains silver, for example.

Two anode terminals 17 are each formed in an angular U-shape and are disposed facing each other. One of anode terminals 17 is electrically connected to end surface 12b of one of protrusions 12a of anode body 12 with a plating layer interposed therebetween (not illustrated). The other of anode terminals 17 is electrically connected to end surface 12b of the other of protrusions 12a of anode body 12 with a plating layer interposed therebetween (not illustrated). The one of anode terminals 17 is electrically connected to output terminal 112 of switching regulator 110. The other of anode terminals 17 is electrically connected to input terminal 130a, 140a of first or second load circuit 130, 140.

Two cathode terminals 18 are each formed in an angular U-shape and are disposed facing each other. One of cathode terminals 18 is electrically connected to one of end surfaces 21a of cathode foil 21 with a plating layer (not illustrated) interposed therebetween. The other of cathode terminals 18 is electrically connected to the other of end surfaces 21a of cathode foil 21 with a plating layer (not illustrated) interposed therebetween. Two cathode terminals 18 are grounded.

### Supplementary Note

Techniques below are disclosed by the description above of the exemplary embodiments.

### Technique 1

A power supply device including:
a switching regulator outputting a DC voltage; and
a solid electrolytic capacitor smoothing the DC voltage of the switching regulator, in which:
the power supply device is configured to input the DC voltage smoothed by the solid electrolytic capacitor to a load circuit,
the solid electrolytic capacitor includes:
   a plurality of capacitor elements stacked on each other;
   two anode terminals;
   a cathode terminal; and
   an outer packaging resin covering the plurality of capacitor elements, the two anode terminals, and the cathode terminal so that a part of each of the two anode terminals and a part of the cathode terminal are exposed from the outer packaging resin,
each of the plurality of capacitor elements includes an anode body and a cathode part disposed on a surface of the anode body with a dielectric layer disposed between the anode body and the cathode part,
the anode body includes two protrusions protruding from both ends of the cathode part,
each of the two anode terminals is electrically connected to a corresponding one of the two protrusions of the anode body,
the cathode terminal is electrically connected to the cathode part,
the two protrusions in each of the plurality of capacitor elements are electrically conducted to each other,
one of the two anode terminals is connected to an output terminal of the switching regulator in a direct current manner, and
another of the two anode terminals is connected to an input terminal of the load circuit in a direct current manner.

### Technique 2

The power supply device described in Technique 1, in which the load circuit is an analog load circuit.

### Technique 3

The power supply device described in Technique 1 or 2, in which the cathode terminal includes:
a mounting surface part exposed from the outer packaging resin; and
a side wall part being continuous with the mounting surface part and rising from the mounting surface part, the side wall part being electrically connected to a side surface of the cathode part.

### Technique 4

The power supply device described in Technique 1 or 2, in which:
the cathode part includes a first part having a first width and a second part having a second width smaller than the first width, and
the cathode terminal includes a side wall part electrically connected to a side surface of the second part of the cathode part.

### Technique 5

The power supply device described in Technique 1 or 2, in which:
the solid electrolytic capacitor further includes a cathode foil electrically connected to the cathode part,
an end surface of each of the two protrusions of the anode body is electrically connected to a corresponding one of the two anode terminals, and
an end surface of the cathode foil is electrically connected to the cathode terminal.

### Technique 6

The power supply device described in any one of Techniques 1 to 5, further including a decoupling capacitor smoothing the DC voltage of the switching regulator,
in which the power supply device is configured to input the DC voltage smoothed by the decoupling capacitor to a digital load circuit.

### Technique 7

The power supply device described in Technique 6, in which DC voltage that the switching regulator outputs is controlled based on a voltage value corresponding to the load circuit and a voltage value corresponding to the digital load circuit.

### Technique 8

The power supply device described in any one of Techniques 1 to 7, further including a decoupling capacitor disposed between ground and each of the two anode terminals of the solid electrolytic capacitor.

### Technique 9

The power supply device described in any one of Techniques 1 to 8, in which:
a plurality of load circuits including the load circuit are provided, and
at least one solid electrolytic capacitor is provided for each of the plurality of load circuits.

### Technique 10

The power supply device described in Technique 9, in which DC voltage that the switching regulator outputs is controlled based on voltage values corresponding to the plurality of load circuits.

### Technique 11

The power supply device described in any one of Techniques 1 to 10, in which DC voltage that the switching regulator outputs is controlled based on a voltage value detected between the solid electrolytic capacitor and the load circuit.

### Technique 12

The power supply device described in any one of Techniques 1 to 11, in which a capacitance value of the solid electrolytic capacitor is 80 μF or more.

### Technique 13

A solid electrolytic capacitor that smooths a DC voltage output by a switching regulator and inputs the DC voltage to a load circuit, the solid electrolytic capacitor including:
a plurality of capacitor elements stacked on each other;
two anode terminals;
a cathode terminal; and
an outer packaging resin covering the plurality of capacitor elements, the two anode terminals, and the cathode terminal so that a part of each of the two anode terminals and a part of the cathode terminal are exposed from the outer packaging resin, in which:
each of the plurality of capacitor elements includes an anode body and a cathode part disposed on a surface of the anode body with a dielectric layer disposed between the anode body and the cathode part,
the anode body includes two protrusions protruding from both ends of the cathode part,
the two anode terminals is electrically connected to the corresponding two protrusions of the anode body,
the cathode terminal is electrically connected to the cathode part,
the two protrusions in each of the plurality of capacitor elements are electrically conducted to each other,
one of the two anode terminals is connected to an output terminal of the switching regulator in a direct current manner, and
another of the two anode terminals is connected to an input terminal of the load circuit in a direct current manner.

### INDUSTRIAL APPLICABILITY

The present disclosure is applicable to a power supply device and a solid electrolytic capacitor.

### REFERENCE MARKS IN THE DRAWINGS

10,10A,10B first and second solid electrolytic capacitors (solid electrolytic capacitors)
11 capacitor element
11a recess
12 anode body
12a protrusion
12b end surface
13 cathode part
13a first part
13b second part
14 dielectric layer
15 insulator
16 conductive paste
17 anode terminal
18 cathode terminal
18a mounting surface part
18b side wall part
19 outer packaging resin
21 cathode foil
21a end surface
100 power supply device
110 switching regulator
111 input terminal
112 output terminal
113 switching element
114 reference voltage unit
115A first voltage detector
115B second voltage detector
115C third voltage detector
116 input voltage detector
117 voltage comparator
118 controller
119 choke coil
120A first decoupling capacitor
120B second decoupling capacitor
120C third decoupling capacitor
130 first load circuit (load circuit)
130a input terminal
140 second load circuit (load circuit)
140a input terminal
150 digital load circuit
150a input terminal

1. A power supply device comprising:
a switching regulator outputting a DC voltage; and
a solid electrolytic capacitor smoothing the DC voltage of the switching regulator, wherein:
the power supply device is configured to input the DC voltage smoothed by the solid electrolytic capacitor to a load circuit,
the solid electrolytic capacitor includes:
a plurality of capacitor elements stacked on each other;
two anode terminals;
a cathode terminal; and
an outer packaging resin covering the plurality of capacitor elements, the two anode terminals, and the cathode terminal so that a part of each of the two anode terminals and a part of the cathode terminal are exposed from the outer packaging resin, each of the plurality of capacitor elements includes an anode body and a cathode part disposed on a surface of the anode body with a dielectric layer disposed between the anode body and the cathode part,
the anode body includes two protrusions, each of the two protrusions protruding from @ ding one of both ends of the cathode part,
each of the two anode terminals is electrically connected to a corresponding one of the two protrusions of the anode body,
the cathode terminal is electrically connected to the cathode part,
the two protrusions in each of the plurality of capacitor elements are electrically conducted to each other,
one of the two anode terminals is connected to an output terminal of the switching regulator in a direct current manner, and
another of the two anode terminals is connected to an input terminal of the load circuit in a direct current manner.

2. The power supply device according to claim 1, wherein the load circuit is an analog load circuit.

3. The power supply device according to claim 1, wherein the cathode terminal includes:
a mounting surface part exposed from the outer packaging resin; and
a side wall part being continuous with the mounting surface part and rising from the mounting surface part, the side wall part being electrically connected to a side surface of the cathode part.

4. The power supply device according to claim 1, wherein:
the cathode part includes a first part having a first width and a second part having a second width smaller than the first width, and
the cathode terminal includes a side wall part electrically connected to a side surface of the second part of the cathode part.

5. The power supply device according to claim 1, wherein:
the solid electrolytic capacitor further includes a cathode foil electrically connected to the cathode part,
an end surface of each of the two protrusions of the anode body is electrically connected to a corresponding one of the two anode terminals, and
an end surface of the cathode foil is electrically connected to the cathode terminal.

6. The power supply device according to claim 1, further including a decoupling capacitor smoothing the DC voltage of the switching regulator,
wherein the power supply device is configured to input the DC voltage smoothed by the decoupling capacitor to a digital load circuit.

7. The power supply device according to claim 6, wherein the DC voltage that the switching regulator outputs is controlled based on a voltage value corresponding to the load circuit and a voltage value corresponding to the digital load circuit.

8. The power supply device according to claim 1, further comprising a decoupling capacitor disposed between ground and each of the two anode terminals of the solid electrolytic capacitor.

9. The power supply device according to claim 1, wherein:
a plurality of load circuits are provided, each of the plurality of load circuit being load circuit, and
one or more of the solid electrolytic capacitor is provided for each of the plurality of load circuits.

10. The power supply device according to claim 9, wherein the DC voltage that the switching regulator outputs is controlled based on each of voltage values corresponding to a corresponding one of the plurality of load circuits.

11. The power supply device described according to claim 1, wherein the DC voltage that the switching regulator outputs is controlled based on a voltage value detected between the solid electrolytic capacitor and the load circuit.

12. The power supply device according to claim 1, wherein a capacitance value of the solid electrolytic capacitor is 80 μF or more.

13. A solid electrolytic capacitor that smooths a DC voltage output from a switching regulator and inputs the DC voltage to a load circuit, the solid electrolytic capacitor including:
a plurality of capacitor elements stacked on each other;
two anode terminals;
a cathode terminal; and
an outer packaging resin covering the plurality of capacitor elements, the two anode terminals, and the cathode terminal so that a part of each of the two anode terminals and a part of the cathode terminal are exposed from the outer packaging resin, wherein:
each of the plurality of capacitor elements includes an anode body and a cathode part disposed on a surface of the anode body with a dielectric layer disposed between the anode body and the cathode part,
the anode body includes two protrusions, each of the two protrusions protruding from a corresponding one of both ends of the cathode part,
each of the two anode terminals is electrically connected to a corresponding one of the two protrusions of the anode body,
the cathode terminal is electrically connected to the cathode part,
the two protrusions in each of the plurality of capacitor elements are electrically conducted to each other,
one of the two anode terminals is connected to an output terminal of the switching regulator in a direct current manner, and
another of the two anode terminals is connected to an input terminal of the load circuit in a direct current manner.
